(19) United States
(12) Patent Application Publication
(10) Pub. No.: US 2022/0048225 A1
(43) Pub. Date: Feb. 17, 2022

(54) CONTINUOUS METHOD FOR PRODUCING A FUNCTIONAL MATERIAL, A RAW MASS FOR A FUNCTIONAL MATERIAL, AND A FUNCTIONAL MATERIAL

(71) Applicant: Puren GmbH, Überlingen (DE)

(72) Inventor: Hans Bommer, Überlingen (DE)

(21) Appl. No.: 17/390,469

(22) Filed: Jul. 30, 2021

(30) Foreign Application Priority Data
Aug. 13, 2020 (DE) DE 10 2020 121 36

(51) Int. Cl. B29C 43/00; B29B 13/10; B29B 7/00; B29C 43/18

(52) U.S. Cl. CPC B29C 43/003; B29B 13/10; B29K 2275/00; B29C 43/18; B29B 7/007

(57) ABSTRACT

A method is proposed for producing a functional material, wherein in at least one mixing step (14) a pulverized rigid foam (16) and at least one binding agent (18) are mixed to form a raw mass, and wherein in at least one pressing step (22) the raw mass is pressed to form the functional material, the method proceeding in a continuous manner at least from the mixing step (14) up to and including the pressing step (22).

### PRIOR ART

The invention concerns a method for producing a functional material, a raw mass produced for this purpose, and the functional material produced therewith.

The production of a functional material from polyurethane rigid foam and a binding agent in a discontinuous method is known from “Recycling von Polyurethan-Kunststoffen” [Recycling of polyurethane plastics”] by W. Rasshofer, Heidelberg (Germany): Huethig GmbH, 1994, ppl 386-390, ISBN 3-92947-08-06. Herein the raw mass in particular stays pressed by means of a press, wherein the raw mass remains in the resting press for a demolding time until hardening in order to form the functional material.

In EP 3 371 250 B1 a functional material is described that is produced in such a manner, the functional material being produced from comminuted PUR rigid foam (polyurethane rigid foam) and/or comminuted PIR rigid foam (polyisocyanurate rigid foam), among others, and a binding agent.

Due to a flow behavior of bulk material implemented of comminuted PUR/PIR rigid foam and to the bulk material levels, required qualities of the functional material can be ensured only by leaving rather wide trims as, when subjected to pressure, the bulk material will flow outwards at the beginning and at the end of a panel implemented of the functional material and at the edges, resulting in so-called soft zones which must be removed afterwards. Such soft zones could be avoided by using a device that encompasses the material that is to be pressed in a frame and the press into the frame in a close fit. This would, however, require some effort and would also take a lot of time as this would affect demolding, and would be economically unfavorable.

From WO 2019/229007 A1 a continuous pressing method for fiber composite panels is known. In continuous processes in which materials are to be densified via pressure and heat, usually so-called throughput heat presses are utilized. In the wood industry, presses of this type, producing one-layer and multilayer wood particle boards with and without surface coatings and with solid or rather loose structures, have been of major importance for many decades.

However, the decisive factor for successful production and for achieving desired technical product characteristics of the functional material are the materials which are to be pressed, a formula of the raw mass produced from the materials and its adaption to a pressing step.

The objective of the invention is in particular to provide a generic method with improved characteristics regarding a required production time for the functional material and regarding a quality of the functional material produced by said method. The objective is achieved according to the invention by the features of claim 1 while advantageous implementations and further developments of the invention may be gathered from the subclaims.

### Advantages of the Invention

A method for producing a functional material is proposed, wherein in at least one mixing step a pulverized rigid foam and at least one binding agent, in particular a binding agent that is liquid at room temperature and under standard pressure, are mixed to form a raw mass, and wherein in at least one pressing step the raw mass is pressed to form the functional material, the method proceeding in a continuous manner at least from the mixing step up to and including the pressing step. The functional material may be used, for example, as a thermal insulation material and/or as a basic material, in particular for housings, furniture, construction, buildings, interior of buildings, vehicle innards, or something like that. Particularly preferentially, the functional material is additionally implemented, in particular in addition to a thermal insulation function, as a structural material. The functional material in particular has a thermal conductivity according to EN 12667 of maximally 0.10 W/(m·K), preferably of less than 0.07 W/(m·K). The functional material in particular has an apparent density that is greater than 150 kg/m³, preferentially greater than 300 kg/m³, and especially preferentially greater than 450 kg/m³. Preferably the functional material has a compression strength according to DIN EN 826 that is greater than 1 MPa, preferentially greater than 3 MPa, and especially preferentially greater than 6 MPa.

The method optionally comprises a comminution step, in which objects containing the rigid foam and/or implemented at least substantially of the rigid foam are mechanically comminuted. By an object being “implemented substantially of a material” is in particular to be understood that at least 50%, preferentially more than 75%, and particularly preferentially more than 90% of a total volume and/or of a total mass of the object are implemented of the material. Preferably the rigid foam is separated from other components of the objects, in particular before the comminution step, during the comminution step and/or after the comminution step. In particular, the rigid foam is pulverized in the comminution step, for example by grinding, by shredding and/or by chopping. Alternatively, the rigid foam is already present in a pulverized form. The pulverized rigid foam is in particular implemented at least substantially of rigid foam particles, which in particular in each case have a cell structure of the rigid foam. Each individual rigid foam particle at least of a major portion of the rigid foam particles of the pulverized rigid foam has in any direction an at least substantially same maximum spatial extent. By two values having a “substantially same” size is in particular to be understood that a greater one of the two possible quotients of the values is smaller than 5, preferentially smaller than 3, particularly preferentially smaller than 2. Maximum spatial extents of different rigid foam particles may be implemented so as to be at least substantially of the same size or may have different sizes. Preferably the pulverized rigid foam has a flour-like consistency. In particular, an average particle size of the pulverized rigid foam is less than 5 mm, preferentially less than 1 mm, particularly preferentially less than 500 μm. Preferentially an average particle size is at least greater than 500 nm, in particular greater than 1 μm, particularly preferentially more than 100 μm. The method preferably comprises a rigid foam metering step, in which the pulverized rigid foam is transferred to a continuous conveyor from a powder silo or directly from a comminution installation for a pulverization of the rigid foam. The continuous conveyor may be implemented as a mechanical conveyor, as a gravity conveyor or as a flow conveyor. In the rigid foam metering step the pulverized rigid foam is in particular transferred to the continuous conveyor continuously with an adjustable rigid foam rate.

In particular under laboratory conditions, before a curing of the binding agent, the binding agent is preferably present as a liquid. Preferentially the binding agent is organic, alternatively inorganic. Preferably the binding agent comprises an isocyanate. Especially preferentially the binding agent comprises at least one methylene diphenyl-isocyanate (MDI). Alternatively or additionally the binding agent comprises toluene-2,4-diisocyanate (TDI), urea or sodium silicate. The method in particular comprises a binding agent metering step, in which the binding agent is added to the pulverized rigid foam. In the binding agent metering step the binding agent is in particular added continuously to the pulverized rigid foam with an adjustable binding agent rate.

In the mixing step the pulverized rigid foam and the binding agent are mixed continuously, in particular by means of a flow mixer, particularly preferentially by means of a screw extruder. Preferably the continuous conveyor feeds the pulverized rigid foam to the flow mixer continuously. Preferably the binding agent is added to, in particular sprayed into, the pulverized rigid foam within the flow mixer. In particular, the raw mass is continuously produced in the mixing step. In particular at the end of the mixing step, the flow mixer outputs the raw mass continuously and transfers the raw mass, in particular continuously, to a further continuous conveyor, on particular a belt conveyor and/or an apron conveyor. In particular, the flow mixer produces an endless sheet of raw mass, which is conveyed continuously to an, in particular continuously operated, throughput press, in particular a heated throughput press, by the further continuous conveyor.

Preferably the method comprises at least one pre-pressing step, in which the raw mass is pre-compressed by means of a throughput device. The method optionally comprises at least one layering step, in which a further layer of the raw mass or of a further raw mass, which in particular has a different quality of the rigid foam and/or a different rigid foam than the raw mass, is applied onto the raw mass, in particular the pre-compressed raw mass.

In the pressing step, the raw mass, in particular the pre-compressed raw mass, is pressed continuously, in particular with the further layers if such are present. Preferably, in the pressing step the raw mass is subjected to a temperature, in particular for an acceleration of a chemical reaction, in particular a polyaddition and/or polycondensation, of the binding agent. Particularly preferentially, in the pressing step, in particular in contrast to a throughput device operated with a clock rate or a multi-platen press, the raw mass is fed to the throughput press continuously, the raw mass is continuously pressed by the throughput press, and the functional material is continuously outputted by the throughput press. The throughput press in particular converts the raw mass into an endless sheet of the functional material, which is continuously conveyed to a confectioning station by the further continuous conveyor. Preferably the method comprises a confectioning step, in which a subsection is separated from the endless sheet of the functional material.

A continuously operable manufacturing installation for the functional material in particular comprises the continuous conveyor, the flow mixer, the further continuous conveyor, the throughput press for pressing, the throughput device for pre-compressing, the confectioning station, a binding agent tank and a binding agent metering device, the powder silo, and a metering device for the pulverized rigid foam and/or the comminution installation, and optionally respectively at least one storage and metering apparatus for an optional filling material and/or for an optional cover layer. The method is in particular executed during an active regular operation state of the manufacturing installation, in particular after starting the manufacturing installation. “Continuous” is to mean, in particular in contrast to a discontinuous start-and-stop operation, preferably steadily running on, preferably for the duration of the method, in particular without interruption. The method is in particular terminated at the latest by a manual or automatic termination of the regular operation state of the manufacturing installation, for example by shutting down the manufacturing installation, by a triggering of an error state and/or of a maintenance state of the manufacturing installation, or something like that. In particular, at least the rigid foam metering step, the binding agent metering step, the mixing step, the pre-pressing step and/or the pressing step are executed on the raw mass or on a precursor of the raw mass simultaneously in different places of the endless sheet. Preferentially the method, in particular in contrast to a discontinuous method, runs automatedly, in particular without an operator's input, at least from the mixing step on, particularly preferentially at least from the rigid foam metering step on, optionally from the comminution step on, at least up to and including the pressing step, preferentially up to and including the confectioning step. In particular, a control unit of the manufacturing installation controls or regulates the manufacturing installation during the method, in particular during the rigid foam metering step, the binding agent metering step, the mixing step, the pre-pressing step, the pressing step and/or the confectioning step, preferably in a fully automated manner. By a “control unit” is in particular a unit with at least one control electronics component to be understood. A “control electronics component” is in particular to mean a unit with a processor unit and with a memory unit and with an operation program stored in the memory unit. In particular, the control unit controls or regulates the manufacturing installation without an operator's input, in particular at least after a pre-setting of the manufacturing installation or after an input of process parameters into the operation program by an operator.

The implementation according to the invention allows keeping a trim that is necessary due to a flow behavior of the raw mass advantageously small. In particular, a trim perpendicularly to a conveying direction of the raw mass, which in particular defines a dimension of a panel, may be dispensed with. In particular, a soft zone occurring at an edge of a pressure area can be kept advantageously small. In particular, an offcutting for removing the soft zone from the functional material having the desired properties can be kept advantageously small. In particular, costly and time-consuming measures for a delimiting of the soft zone, for example a frame construction for the raw mass closely fitting with a discontinuous press, may be dispensed with. In particular, high-quality cover layers can be applied already onto the raw mass with advantageously small offcut, such that the functional material can be provided with high-quality cover layers in an advantageously cost-efficient manner. In particular, a separate work step for an application of the cover layers onto the—in particular ready-cut—panels of functional material can be dispensed with. Furthermore, even with a functional material having a great material thickness, in particular a material thickness of more than 20 mm, for the curing of which a huge quantity of water vapor is necessary, a vapor pressure within the raw mass and the functional material can be kept advantageously low, and it is in particular possible to avoid a sudden drop in pressure when opening the discontinuous press. In this way a risk of ruptures forming in the functional material after the pressing step can be kept advantageously low. In particular, with a functional material having a small material thickness, in particular a material thickness of less than 10 mm, a necessary duration of the pressing step can be kept advantageously short, in particular shorter than a duration of time required for preparing the raw mass. This allows achieving an advantageously high production capacity. In particular, the functional material can be produced advantageously quickly. It is moreover advantageously possible to dispense with a cooling press. Furthermore, advantageously any desired length of a panel implemented of the manufacturing material may be selected, the length in particular being not limited by a dimension of the throughput press. It is in particular possible to dispense with re-fitting the manufacturing installation in order to change a length of the panel.

It is further proposed that in at least one method step the pulverized rigid foam is produced from polyurethane rigid foam, PUR for short, from polyisocyanurate rigid foam, PIR for short, and/or from phenolic rigid foam. The rigid foam is in particular at least substantially pressure-resistant. “At least substantially pressure-resistant” is in particular to mean in accordance with the standard EN 826, and advantageously resistant to a pressure of more than 100 kPa, preferentially more than 120 kPa. In particular, “PUR” is to mean a rigid foam material according to DIN EN 13165 and/or EN 14308. In particular, “PIR” is to mean a rigid foam material according to EN 14308 and/or ASTM C 1289. In particular, the pulverized rigid foam is implemented at least substantially of a thermoset material. Before pulverization the rigid foam preferably has a thermal conductivity, in particular according to EN 12667, of less than 0.037 W/Km. Preferentially, before pulverization the rigid foam has a thermal conductivity according to EN 12667 of less than 0.03 W/Km, particularly preferentially of less than 0.025 W/Km. The rigid foam particles are in particular obtained by mechanical comminution, such that the cell structure of the rigid foam is at least partly maintained in the rigid foam particles. In particular, a thermal conductivity of the individual rigid foam particles is at least substantially equal to the thermal conductivity of the rigid foam before the comminution. In particular, the comminuted rigid foam limits a thermal conduction within the raw mass. Preferably, water, in particular an aqueous solution, is mixed into the binding agent in the mixing step and/or in a binding agent mixing step prior to the mixing step. In particular, the water is vaporized in the pressing step. Preferably, in the pressing step the vaporized water is at least for the most part enclosed in the raw mass for a curing duration, which is in particular equivalent to a throughput duration through the throughput press. Optionally the vaporized water is discharged from the raw mass and/or from the functional material partly during the curing duration and preferentially at least for the most part after the pressing step, in particular continuously. “For the most part” is in particular to mean by at least 50%, preferentially by at least 75%, especially preferentially by at least 90% of a total volume and/or of a total mass. In particular, the vaporized water is intended for a heat exchange within the raw mass, and is in particular intended for an even curing of the binding agent. “Configured” is in particular to mean specifically designed and/or specifically equipped. By an object being configured for a certain function is in particular to be understood that the object fulfills and/or executes said certain function in at least one application state and/or operation state. The implementation according to the invention advantageously permits producing the functional material in a resource-saving manner, in particular from industrial residual materials and/or from offcuts.

Beyond this it is proposed that in at least one method step activated water with a mass fraction of an activator of maximally 3% is mixed into the binding agent. The activated water is in particular the aforementioned water which is intended for vaporization and which the activator has been added to additionally. The mass fraction of the activator in particular relates to a total mass of an aqueous solution of the water and the activator. In particular, in the binding agent pre-mixing step the activator is dissolved in the water for producing the aqueous solution. For example, kalium acetate, kalium octoate, an amine activator and/or a different activator deemed expedient by someone skilled in the art are/is added. The activator preferentially has a mass fraction of less than 2%, especially preferentially of less than 1%. Preferably the activator has a mass fraction of at least 0.01%, especially of at least 0.05%. Prior to the addition of the activator, the water may have a quality of industrial water, filtered water, distilled water, fully desalinated water or high-purity water. Alternatively, the water, in particular without an activator, is added to the binding agent. In particular, a curing duration of the raw mass is predetermined, among other factors, by a ratio of a quantity of the water and of the activator to a material thickness of the raw mass and/or of the functional material. The implementation according to the invention allows—with equal curing duration—keeping the required water quantity advantageously small, and/or—with equal water quantity—keeping the curing duration advantageously short. In particular, if a small water quantity is used, a vapor pressure withing the throughput press can be kept advantageously low, and/or the raw mass can be subjected to an advantageously high temperature, such that the same vapor pressure is achieved with a smaller quantity of water. In particular, an advantageously reliable curing of the binding agent is achievable. In particular, an advantageously quick curing of the binding agent is achievable. It is in particular possible to further increase manufacturing capacity. Moreover, a risk of ruptures forming, in particular despite quick curing, due to a sudden drop in the vapor pressure at an output of the throughput press can be kept advantageously low.

Furthermore, it is proposed that in the mixing step the binding agent is mixed into the pulverized rigid foam with a mass fraction of less than 10% relative to a total mass of the functional material. Preferentially the mass fraction of the binding agent in the functional material is less than 9%, particularly preferentially less than 8%. Optionally the binding agent is mixed into the pulverized rigid foam with a mass fraction of the functional material that is at least 5%, in particular more than 6%. Preferentially the pulverized rigid foam constitutes a mass fraction of the functional material of more than 60%, preferentially more than 75%, especially preferentially more than 85% of the functional material. The method optionally comprises a further mixing step, which in particular substitutes the mixing step in at least one setting of the manufacturing installation, in particular for a production of the functional material with an apparent density of more than 500 kg/m³ and/or more than 600 kg/m³, in which the binding agent is added with a mass fraction of more than 10%, in particular up to 12%, preferentially up to 15%, particularly preferentially up to 18%, relative to a total mass of the functional material. The implementation according to the invention allows producing the functional material with an advantageously low thermal conductivity. It is in particular possible to keep health-hazardous components of the raw mass at an advantageously low level. It is in particular possible to produce the functional material in an advantageously cost-efficient manner.

It is also proposed that in at least one method step at least one organic and/or inorganic filling material is added to the raw mass, the pulverized rigid foam and/or the binding agent. Preferably the filling material is fed in before and/or during the mixing step. Especially preferentially the filling material is fed to the pulverized rigid foam before the mixing step, and is in particular fed to the flow mixer together with the pulverized rigid foam. The filling material is preferably implemented as a solid material, which is added to the pulverized rigid foam and/or to the binding agent as a powder or as a granulate. Alternatively, the filling material or a further filling material is implemented as a fiber material, which is at least substantially implemented of mineral fibers or non-mineral fibers like, for example, glass fibers, carbon fibers, ceramic fibers or basalt fibers. The filling material preferably constitutes a mass fraction of the total mass of the functional material that is smaller than 20%. Preferably the filling material constitutes a mass fraction of the total mass of the functional material of more than 1%, in particular more than 2%. The implementation according to the invention allows providing the functional material, advantageously depending on a respective application, with additional characteristics, in particular with an advantageously low influence, in particular an advantageously low negative influence, on mechanical and thermal characteristics of the functional material.

Furthermore, it is proposed that the filling material makes the functional material difficult to ignite according to combustibility class C of DIN 13501-1. When subjected to heat, the filling material preferably has an intumescence behavior as a result of which an apparent density of the filling material changes if a temperature of the functional material exceeds an activation temperature of the filling material. In an original state the filling material has an apparent density that is in particular smaller than 5 g/cm³. Preferentially the apparent density of the filling material is between 1 g/cm³ and 3 g/cm³. The filling material preferentially has an expansion rate of at least 30 cm³/g, in particular in a standard atmosphere. Preferably the expansion rate of the filling material is greater than 100 cm³/g and is preferentially in a range between 250 cm³/g and 450 cm³/g, in particular in a standard atmosphere. The intumescence behavior of the filling material results, in particular in a standard atmosphere, in a volume increase of the filling material by a factor that is preferably at least 10 if the functional material is heated to a temperature that is greater than the activation temperature of the filling material. The filling material in particular has an activation temperature of at least 90° C. Preferably the activation temperature is above 120° C. In particular, the raw mass is in the pressing step subjected to a temperature below the activation temperature. If the functional material with the filling material is heated to the activation temperature of the filling material, the filling material preferably expands. A volume fraction of the filling material changes if a temperature of the functional material exceeds the activation temperature of the filling material. The filling material has a carbon content that is preferably at least 85% but may as well be smaller. The filling material preferably comprises graphite. The filling material is particularly preferentially implemented as an expanded graphite. The filling material in particular comprises acid molecules which are embedded between layers of the graphite. In particular, if the filling material is heated above the activation temperature, the layers expand and the volume increases. The functional material preferably has a combustion behavior according to building material class B1 according to DIN 4102-1. The implementation according to the invention enables a production of an advantageously secure functional material, which is usable, in particular admissible, in an advantageously wide range of application areas.

Beyond this it is proposed that in the pressing step, in at least one setting of the throughput press, the raw mass is pressed by the throughput press to form a panel with a material thickness of less than 8 mm, in particular without subsequent grinding. The further continuous conveyor in particular has a conveying direction from the flow mixer, in particular through the throughput device, to the throughput press, and in particular through the throughput press further on to the confectioning station. The conveying direction is preferably parallel to a straight line. Alternatively, the conveying direction comprises at least one bend, a turning point, or something like that. The continuous conveyor has a maximum conveying width, which is perpendicular to the conveying direction, and on which the raw mass is distributed in a raw mass metering step by means of a banking-up device arranged on the flow mixer, and which preferably has a constant value along the conveying direction. In particular, the banking-up device banks the raw mass up on the further continuous conveyor with a maximum width in parallel to the conveying width of the further continuous conveyor that is at least 50 cm, preferentially more than 80 cm, particularly preferentially more than 1.1 m. In particular, while the method is running, the raw mass extends in parallel to the conveying direction of the further continuous conveyor from a banking-up place of the further continuous conveyor to the throughput press without interruption, in particular over several meters. A material thickness of the raw mass and of the functional material in particular extends perpendicularly to the conveying direction and perpendicularly to the conveying width. In particular, the throughput press reduces the material thickness of the raw mass to the material thickness of the functional material. In particular, in at least one method step the throughput press is adjusted such that a material thickness of the functional material results that is less than 8 mm, in particular less than 7 mm, preferentially less than 6 mm, especially preferentially less than 5 mm. Optionally the throughput press is also adjustable for material thicknesses which are greater than 8 mm. In particular, in at least one method step the raw mass is pressed so as to form the functional material with a material thickness of more than 10 mm, in particular more than 40 mm, preferentially more than 70 mm, especially preferentially up to 100 mm. In particular, the confectioning station separates the panel from the endless sheet of the functional material, which leaves the throughput press with an adjustable length in parallel to the conveying direction. The confectioning station is in particular configured to separate the panel off with a maximum length parallel to the conveying direction of more than 1 m, preferentially more than 5 m, particularly preferentially more than 20 m, and in particular to convey the separated-off panel individually or several panels stack-wise to a transporting, packaging and/or storage device. The implementation according to the invention enables a production of an advantageously thin functional material with in particular high insulation capacity. In particular, it is also possible to utilize the functional material in applications having little construction space available.

It is moreover proposed that in the pressing step the raw mass is pressed to form a panel with a material thickness whose maximally admissible tolerance is at most 1 mm, in particular without subsequent grinding. The method optionally comprises a grinding step for the purpose of increasing a surface quality of the functional material after the pressing step, wherein the maximally admissible tolerance of the material thickness is already achieved by the pressing step. Preferentially the grinding step is dispensed with, as a result of which the panel in particular has an advantageously high adhesion for a subsequent application of a cover layer, for example a functional layer and/or decorative layer. The implementation according to the invention allows keeping material loss for straightening the functional material at an advantageously low level.

It is further proposed that in at least one method step the functional material is pulverized and the pulverized rigid foam is substituted at least partially by the pulverized functional material. In particular, the functional material and objects produced from the functional material can be recycled within the method. Preferably, in the comminution step the functional material is pulverized, in particular together with or separately from the rigid foam material. Optionally binding agent residue of the functional material is filtered out of the pulverized functional material, in particular depending on its mass and/or density. Alternatively, the binding agent residue is left in the pulverized functional material. The pulverized functional material is preferably mixed with pulverized rigid foam, which in particular has a higher degree of purity, in the mixing step or in the comminution step. Alternatively, the pulverized rigid foam is completely substituted by the pulverized functional material. The implementation according to the invention advantageously allows establishing a closed cycle for the rigid foam. In particular, the functional material is producible in an advantageously resource-saving and advantageously environmentally friendly manner.

Furthermore, it is proposed that in at least one method step of the method an open time of the raw mass is set depending on properties of the functional material that is to be produced. The open time in particular designates the time duration from the binding agent metering step to the pressing step. In particular, the set open time is longer than a minimum open time, which is in particular necessary for a soaking of the pulverized rigid foam with the binding agent and the activated water, and for a preferably homogeneous distribution of the binding agent and the activated water in the pulverized rigid foam. In particular, the set open time is shorter than a maximum open time in order to keep a drying out of the raw mass, chemical reactions within the raw mass, in particular a precipitous polyaddition and/or polycondensation of the binding agent or the like, as low as possible. The open time can be set by an operator or by the control unit depending on the properties of the functional material that is to be produced. In particular, the open time is defined on the basis of a conveying speed of the flow mixer and/or of the further continuous conveyor. The properties of the functional material that is to be produced, which the open time, in particular the minimum open time and the maximum open time, depends/depend on, comprise for example a density of the functional material, the material thickness of the functional material, a number of layers of the functional material. In particular, the open time is set to be the longer, the greater the density, the thickness and/or the number of layers of the functional material are/is that is to be produced. In particular, the open time is set so as to be the shorter, the smaller the density and/or the thickness of the functional material are/is that is to be produced and/or the less layers the functional material has that is to be produced. The implementation according to the invention enables an advantageously flexible adaption of the properties of the functional material. In particular, advantageously the same manufacturing installation is capable of producing differently implemented functional materials, in particular without re-fitting. It is in particular possible to produce different functional materials advantageously quickly and with an advantageously reliable quality.

Beyond this it is proposed that in the raw mass metering step the raw mass is applied onto a separating layer, which is in particular arranged at least temporarily on the functional material, and which is removed from the functional material after the pressing step. Preferably the separating layer is implemented as a separating paper or as a separating film, for example as a Teflon film or as a nonwoven material. In particular, the separating layer is pulled onto the further continuous conveyor before or at the start of the raw mass metering step. Especially preferentially, then or at the end of the raw mass metering step, in particular before the pressing step, a further separating layer is arranged on a side of the raw mass facing away from the separating layer. In particular, before the pressing step the separating layer, the raw mass and the further separating layer form a sandwich structure. Especially preferentially, after the pressing step or after the confectioning step, the separating layer and/or the further separating layer are/is pulled, alternatively ground, off the functional material. The implementation according to the invention advantageously enables low-wear operation of the throughput press. It is in particular possible to keep sedimentation within the throughput press and/or within the continuous conveyor advantageously low. In particular, the pressing step can be operated without maintenance for an advantageously long time. Furthermore, by pulling the separating layer off, an advantageously rough surface of the functional material can be brought about, to which a subsequently applied coating will advantageously adhere reliably.

It is moreover proposed that in the raw mass metering step the raw mass is applied onto a cover layer, which is after the pressing step connected to the cured raw mass by substance-to-substance bond. The cover layer is arranged on the separating layer or on the further continuous conveyor before or at the start of the raw mass metering step. Optionally, then or at the end of the raw mass metering step, in particular before the pressing step, a further cover layer is arranged on a side of the raw mass that faces away from the cover layer. In particular, before the pressing step the cover layer, the raw mass and the further cover layer form a sandwich structure. The cover layer and the further cover layer may be made of the same material or of different materials. The cover layer and/or the further cover layer may be implemented at least substantially of an organic material, for example a melamine resin and/or a polyvinylchloride, or of an inorganic material, for example aluminum. Especially preferentially the separating layer and/or the further separating layer if existent, are/is pulled, alternatively ground, off the cover layers after the pressing step or after the confectioning step. The implementation according to the invention permits providing the functional material with additional characteristics, advantageously depending on an application. For example, cover layers may be realized as a moisture barrier, as an anti-microbiological protective layer, as a weather protection, as a soundproofing, as a high-quality decoration, or something like that. In particular, a subsequent application step for an application of the cover layers onto the functional material can be dispensed with, thus enabling a production of a functional material with cover layers which is advantageously fast and advantageously cost-efficient.

Moreover, a raw mass is proposed for a production of the functional material by a method according to the invention. The raw mass preferably comprises at least the pulverized rigid foam and/or pulverized functional material. The raw mass in particular comprises the liquid binding agent. The raw mass preferably comprises the activated water or the water, in particular without an activator. Preferably, the activated water or the water constitutes a mass fraction of the raw mass that is at least 0.5%, preferentially more than 1%, particularly preferentially more than 2%. Preferably the mass fraction of the activated water or of the water in the raw mass is less than 7.5%, preferentially less than 5%, particularly preferentially less than 3%. The raw mass preferably comprises the filling material. Preferably the pulverized rigid foam and/or the pulverized functional material, the binding agent, optionally the filling material and the activated water or the water, are distributed homogeneously in the raw mass wherein, in particular in case of several layers, the distribution is at least layer-wise homogeneous. The implementation according to the invention allows providing a raw mass for the functional material which can be processed in an advantageously continuous and advantageously quick fashion.

Furthermore, a functional material is proposed which is produced by a method according to the invention. The functional material in particular has a thermal conductivity according to EN 12667 of maximally 0.10 W/(m·K), preferably of less than 0.07 W/(m·K). The functional material in particular has an apparent density that is in particular greater than 150 kg/m³, preferentially greater than 300 kg/m³, especially preferentially greater than 450 kg/m³, and in particular has a compression strength according to DIN EN 826 that is greater than 1 MPa, preferentially greater than 3 MPa, and especially preferentially greater than 6 MPa. The functional material is preferably decomposition-resistant and rot-proof. The functional material is preferably resistant against mineral oils and solvents as well as diluted bases and acids. Preferably the functional material has a flexural strength according to DIN EN 12089 that is greater than 1 MPa, preferentially greater than 2 MPa, especially preferentially greater than 4 MPa. Preferentially the functional material has a shearing resistance according to DIN EN 12090 that is greater than 250 kPa, preferentially greater than 500 kPa, particularly preferentially greater than 1 MPa. The functional material has a transverse strength according to DIN EN 12090 that is in particular greater than 250 kPa, preferentially greater than 500 kPa, especially preferentially greater than 1 MPa. Preferably the functional material further has a resistance to axial withdrawal of screws according to DIN EN 14358 that is at least 4.5 N/mm², preferentially more than 6 N/mm², especially preferentially more than 7.5 N/mm², for a surface withdrawal of a 6×60 wood screw. A basic composition of the functional material, which is implemented only of the pulverized rigid foam and the binding agent, in particular has a combustion behavior that corresponds to a combustion reaction class E according to DIN EN 13501-1 and to a building material class B2 according to DIN 4102-1. Because of the filling material, the functional material has a combustion behavior corresponding at least to a combustion reaction class C according to DIN EN 13501-1 and at least to a building material class B1 according to DIN 4102-1. The implementation according to the invention allows providing an advantageously stable and at the same time advantageously heat-insulating functional material, which is producible in an advantageously cost-efficient, advantageously resource-saving, advantageously quick manner and/or with advantageously small fluctuations of characteristics, in particular advantageously small fluctuations of apparent density.

The method according to the invention, the raw mass according to the invention and/or the functional material according to the invention shall herein not to be limited to the application and implementation described above. In particular, to fulfill a functionality that is described here, the method according to the invention, the raw mass according to the invention and/or the functional material according to the invention may comprise a number of individual elements, components and units as well as method steps that differs from a number given here. Moreover, in regard to the value ranges given in the present disclosure, values situated within the limits named shall also be considered to be disclosed and usable as applicable.

### DRAWINGS

Further advantages will become apparent from the following description of the drawings. In the drawings an exemplary embodiment of the invention is illustrated. The drawings, the description and the claims contain a plurality of features in combination. Someone skilled in the art will purposefully also consider the features separately and will find further expedient combinations.

It is shown in:

FIG. 1 a schematic representation of a method according to the invention, and

FIG. 2 a schematic representation of a functional material according to the invention.

### DESCRIPTION OF THE EXEMPLARY EMBODIMENT

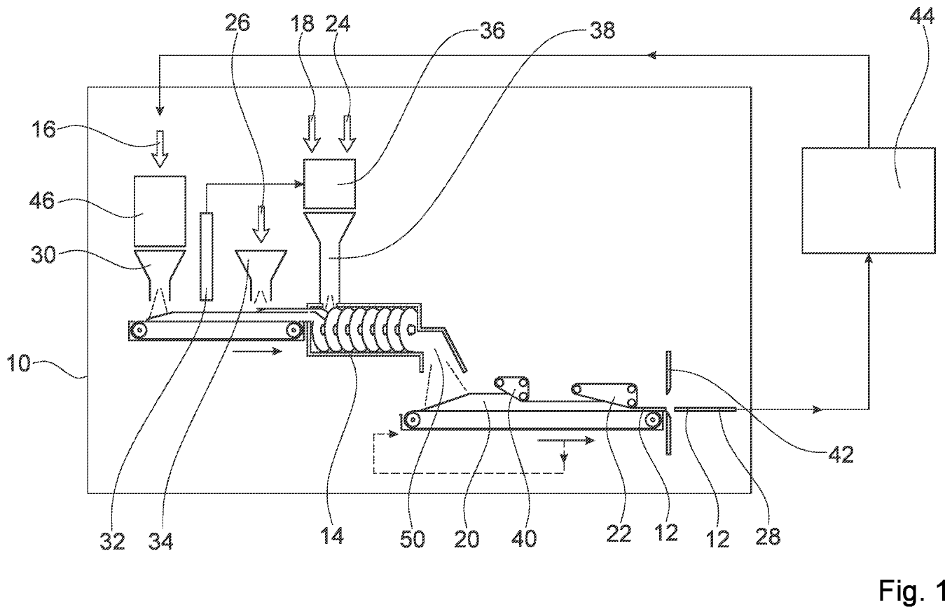

FIG. 1 shows a sequence of a method 10 for a production of a functional material 12. The functional material 12 is produced from at least one rigid foam 16 and a binding agent 18. The rigid foam 16 is pulverized, is mixed with the binding agent 18 and is pressed to form the functional material 12.

The method 10 in particular comprises a comminution step 46. The method 10 comprises a rigid foam metering step 30. The method 10 optionally comprises a moisture measuring step 32. The method 10 preferably comprises a filling material metering step 34. The method 10 preferably comprises a binding agent pre-mixing step 36. The method 10 comprises a binding agent metering step 38. The method 10 comprises a mixing step 14. The method 10 preferably comprises a raw mass metering step 50. The method 10 in particular comprises a pre-pressing step 40. The method 10 comprises a pressing step 22. The method 10 preferably comprises a confectioning step 42. The method 10 proceeds continuously at least from the mixing step 14 up to and including the pressing step 22. Especially preferentially the method 10 proceeds continuously from the rigid foam metering step 30 up to and including the pressing step 22. In particular, the rigid foam metering step 30, the filling material metering step 34, optionally the binding agent pre-mixing step 36, the binding agent metering step 38, the mixing step 14, the pre-pressing step 40 and the pressing step 22 are executed continuously and in particular temporally in parallel to one another. The moisture measuring step 32 can be executed continuously, regularly or sample-wise. The confectioning step 42 is executed discontinuously, in particular triggered by a timing and/or by a length measurement of the functional material 12. The comminution step 42 may be carried out continuously or discontinuously. Preferably the comminution step 42 is carried out independently from the other method steps of the method 10.

The rigid foam 16 has a thermal conductivity of less than 0.037 W/Km before pulverization. In the comminution step 46 the pulverized rigid foam 16 is produced from polyurethane rigid foam, PUR for short, from polyisocyanurate rigid foam, PIR for short, and/or from phenolic rigid foam. In the comminution step 46, the rigid foam 16 is mechanically comminuted, in particular pulverized. Preferably the pulverized rigid foam 16 is temporarily stored in a powder silo. In the rigid foam metering step 30 the pulverized rigid foam 16 is continuously applied onto a continuous conveyor. The continuous conveyor transports the pulverized rigid foam 16 to a flow mixer. In the moisture measuring step 32 preferably a moisture content of the pulverized rigid foam 16 is determined, for example by means of a moisture measuring apparatus or by weighing a fix volume of the pulverized rigid foam 16 and comparison with a reference having a known moisture, in particular a reference without moisture. The moisture measuring step 32 may be carried out before or after the rigid foam metering step 30.

In the filling material metering step 34 the pulverized rigid foam 16 is mixed with at least one organic and/or inorganic filling material 26. The filling material 26 makes the functional material 12 difficult to ignite according to combustion reaction class C according to DIN 13501-1. The filling material 26 is in particular implemented as an expanded graphite. The filling material metering step 34 is preferably executed after the moisture measuring step 32, in particular before the mixing step 14. Especially preferentially, in the filling material metering step 34, the filling material 26 is continuously applied onto the pulverized rigid foam 16 and is in particular fed, together with the pulverized rigid foam 16, from the continuous conveyor to the flow mixer.

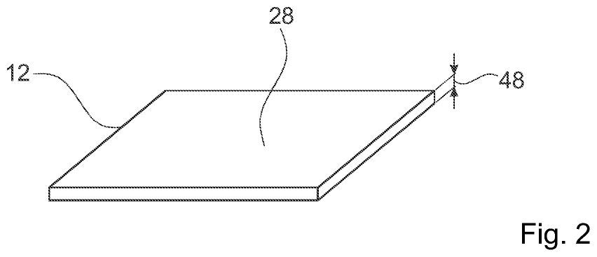

In the binding agent pre-mixing step 36, activated water 24 with a mass fraction of an activator of maximally 3% is mixed into the binding agent 18. Preferably a control unit controls or regulates the quantity of the added activated water 24 depending on the moisture measuring step 32 and in particular depending on a density and a material thickness 48 of the functional material 12 that are to be achieved (see FIG. 2). In the binding agent metering step 38, the binding agent 18, mixed with the activated water 24, is continuously added to the pulverized rigid foam 16, in particular within the flow mixer. Alternatively, the binding agent 18 and the activated water 24 are let into the flow mixer, in particular sprayed into the flow mixer, separately from each other.

In the mixing step 14 the pulverized rigid foam 16 and the binding agent 18, in particular together with the filling material 26 and the activated water 24, are mixed to form a raw mass 20. In the mixing step 14, the binding agent 18, with a mass fraction of less than 10% relative to a total mass of the functional material 12, is mixed into the pulverized rigid foam 16. In the raw mass metering step 50, a banking-up device that is arranged on the flow mixer transfers the raw mass 20 continuously to a further continuous conveyor, in particular to a conveyor belt. Optionally, the raw mass 20 is in the raw mass metering step 50 applied onto a cover layer, which is after the pressing step 22 connected to the cured raw mass by substance-to-substance bond. Optionally, the raw mass 20 is in the raw mass metering step 50 applied onto a separating layer, which is removed from the functional material 12 after the pressing step 22. If the functional material 12 is to comprise a cover layer, the separating layer is applied onto the further continuous conveyor, the cover layer is applied onto the separating layer and the raw mass 20 is applied onto the cover layer. An open time of the raw mass 20 is set depending on properties of the functional material 12 that is to be produced. In particular, a conveying speed of the further continuous conveyor is adjusted or regulated by the control unit depending on the properties of the functional material 12 that is to be produced.

In the pre-pressing step 40 the raw mass 20 is pre-compressed by means of a throughput device. Optionally, at least one further layer of the raw mass 20 or of a further raw mass 20 is applied onto the pre-compressed raw mass 20 and is then pre-compressed. In the pressing step 22, the raw mass 20, in particular the pre-compressed raw mass 20, is pressed to form the functional material 12. In particular, in the pressing step 22 a throughput press subjects the raw mass 20 to pressure and temperature. Preferably the temperature induced by the throughput press is lower than an activation temperature of the filling material 26, at which the filling material 26 preferably presents an intumescence behavior. In the pressing step 22, the throughput press vaporizes the activated water 24. During the pressing step 22, the throughput press encloses the vaporized water for the most part in the raw mass 20, in particular until the binding agent 18 has been cured. The functional material 12 continuously discharges the vaporized water 24, in particular via an outlet of the throughput press for the functional material 12 out of the throughput press. In the pressing step 22, in at least one setting of the throughput press, the raw mass 20 is pressed by the throughput press to form a panel 28 with a material thickness 48 of less than 8 mm, in particular without subsequent grinding. The panel 28 implemented of the functional material 12 is exemplarily shown in FIG. 2. In the pressing step 22 the raw mass 20 is pressed to form the panel 28 with the material thickness 48, whose maximally admissible tolerance is at most 1 mm, in particular without subsequent grinding. In the confectioning step 42 the panel 28 is separated, in particular cut and/or sawn, off the functional material 12 which continuously exits the throughput press.

A usage 44 of the panel 28 that is implemented of the functional material 12 takes place, for example, as a heat insulation and/or as a construction material. The panel 28 implemented of the functional material 12 is recyclable by means of the method 10, in particular after the usage 44. In particular, an offcut of the panel 28 resulting before or during the usage 44 is recyclable. The functional material 12 is pulverized, such that the pulverized rigid foam 16 can be substituted at least partly by the pulverized functional material.

### REFERENCE NUMERALS

10 method
12 functional material
14 mixing step
16 rigid foam
18 binding agent
20 raw mass
22 pressing step
24 activated water
26 filling material
28 panel
30 rigid foam metering step
32 moisture measuring step
34 filling material metering step
36 binding agent pre-mixing step
38 binding agent metering step
40 pre-pressing step
42 confectioning step
44 usage
46 comminution step
48 material thickness
50 raw mass metering step

1. A method for producing a functional material, wherein in at least one mixing step a pulverized rigid foam and at least one binding agent are mixed to form a raw mass, and wherein in at least one pressing step the raw mass is pressed to form the functional material, the method proceeding in a continuous manner at least from the mixing step up to and including the pressing step.

2. The method according to claim 1, wherein in at least one method step the pulverized rigid foam is produced from polyurethane rigid foam, PUR for short, from polyisocyanurate rigid foam, PIR for short, and/or from phenolic rigid foam.

3. The method according to claim 1, wherein in at least one method step activated water with a mass fraction of an activator of maximally 3% is mixed into the binding agent.

4. The method according to claim 1, wherein in the mixing step the binding agent is mixed into the pulverized rigid foam with a mass fraction of less than 10% relative to a total mass of the functional material.

5. The method according to claim 1, wherein in at least one method step at least one organic and/or inorganic filling material is added to the raw mass, the pulverized rigid foam and/or the binding agent.

6. The method according to claim 5, wherein the filling material makes the functional material difficult to ignite according to combustibility class C of DIN EN 13501-1 [German/European standard 13501-1].

7. The method according to claim 1, that wherein in the pressing step, in at least one setting of a throughput press, the raw mass is pressed by the throughput press to form a panel with a material thickness of less than 8 mm, in particular without subsequent grinding.

8. The method according to claim 1, wherein in the pressing step the raw mass is pressed to form a panel with a material thickness whose maximally admissible tolerance is at most 1 mm, in particular without subsequent grinding.

9. The method according to claim 1, wherein in at least one method step the functional material is pulverized and the pulverized rigid foam is substituted at least partially by the pulverized functional material.

10. The method according to claim 1, wherein in at least one method step an open time of the raw mass is set depending on properties of the functional material that is to be produced.

11. The method according to claim 1, wherein in a raw mass metering step the raw mass is applied onto a separating layer, which is removed from the functional material after the pressing step.

12. The method according to claim 1, wherein in a raw mass metering step the raw mass is applied onto a cover layer, which is after the pressing step connected to the cured raw mass by substance-to-substance bond.

13. A raw mass for a production of the functional material by a method according to claim 1.

14. A functional material produced by a method according to claim 1.
